(19) United States
(12) Patent Application Publication
(10) Pub. No.: US 2026/0154036 A1
(43) Pub. Date: Jun. 4, 2026

(54) DIFFERENTIAL PRIVACY NOISE GENERATION IN SECURE MULTIPARTY COMPUTATION

(71) Applicants: Beijing Zitiao Network Technology Co., Ltd., Beijing (CN); Lemon Inc., Grand Cayman (KY)

(72) Inventors: Yongchuan NIU, Beijing (CN); Donghang LU, CULVER CITY, CA (US); Li WANG, Beijing (CN); Qiang YAN, Beijing (CN)

(21) Appl. No.: 18/967,261

(22) Filed: Dec. 3, 2024

(51) Int. Cl. G06F 7/58

(52) U.S. Cl. CPC G06F 7/588

(57) ABSTRACT

Methods, systems, and apparatus, including computer programs encoded on computer storage media, for generating differential privacy noise. One example method includes generating, by a first party of two or more parties participating in a secure multiparty computation (MPC) instance, a first l-bit random number, where l is a positive integer; comparing a XOR result of the first l-bit random number and a second l-bit random number with an integer determined based on a target probability of a Bernoulli distribution, where the comparing comprises performing a comparison protocol based on oblivious transfer; and determining a Bernoulli sampling of a random number based on a result of the comparing. The Bernoulli sampling of the random number can be used to generate a random noise value, which can be added to an MPC computation result according to a differential privacy mechanism.

### TECHNICAL FIELD

This specification relates to data processing, and in particular, to secure multiparty computation.

### BACKGROUND

Data plays an increasingly important role in modern society, driving advancements across various sectors. Effective collaboration among data custodians can be beneficial to the value of data. On the other hand, data collaboration may be compromised by isolated data silos due to the control of data by different entities, regulatory compliance on data privacy across countries, and frequent privacy breaches, etc.

Secure multi-party computation (MPC) is a technique developed to address some of the issues in data collaborations. MPC allows parties to jointly evaluate or analyze their respective private data without sharing the private data with others. Thus, data privacy of each party is protected. As data volumes increase, the computational and communication complexities of MPC also escalate significantly. Therefore, MPC protocols are also developed for specific use scenarios to meet practical data security and computational needs.

### SUMMARY

This specification describes technologies for collaboratively generating shared differential privacy noise in a two-server setting. These technologies generally involve leveraging characteristics of MPC to collaboratively sample random noise according to a discrete Gaussian distribution and output the noise in the form of secret sharing. This specification further describes technologies for providing a distributed sampling protocol for Bernoulli distribution in a two-server setting. While generally described in a two-party setting, the technologies can be generalized to multi-party settings.

According to a first aspect, a method is provided. The method includes generating, by a first server of a first party of two or more parties participating in a secure multiparty computation (MPC) instance, a first l-bit random number, where l is a positive integer; comparing a XOR result of the first l-bit random number and a second l-bit random number with an integer determined based on a target probability of a Bernoulli distribution, where the comparing includes performing a comparison protocol based on oblivious transfer; and determining a Bernoulli sampling of a random number based on a result of the comparing. The Bernoulli sampling of the random number can be used to generate a random noise value, which can be added an MPC computation result according to a differential privacy mechanism.

With reference to the first aspect, in some implementations, the second l-bit random number is generated by a second server of a second party of the two or more parties participating in the secure MPC instance.

With reference to the first aspect, in some implementations, the integer is a product of the target probability and 2^{l}.

With reference to the first aspect, in some implementations, comparing the XOR result with the integer includes partitioning the first l-bit random number into N sections and partitioning the integer into N sections, where N is a positive integer; determining whether the XOR result is smaller than the integer based on first indicators and second indicators corresponding to the N sections. The first indicators include a first indicator that indicates a comparison result between xⱼ⊕yⱼ and uⱼ computed based on oblivious transfer, where xⱼ is a jth section of the first l-bit random number, yⱼ is a jth section of N sections of the second l-bit random number, uⱼ is a jth section of the integer, and j=0, 1, . . . , N-1, and symbol ⊕ represents XOR. The second indicators include a second indicator that indicates whether xⱼ⊕yⱼ is a most significant section among sections of the XOR result where xⱼ⊕yⱼ≠up.

With reference to the first aspect, in some implementations, the method further includes
for the jth section (xⱼ) of the first l-bit random number: receiving, by the first server of the first party, a first secret share of the first indicator; sending, to a second server of a second party of the one or more parties, a second secret share of the first indicator; receiving, by the first server of the first party, a first secret share of the second indicator; and sending, to the second server of the second party, a second secret share of the second indicator.

With reference to the first aspect, in some implementations, the method further includes receiving, by the first server of the first party, a first secret share of a third indicator that indicates whether xⱼ⊕yⱼ=u. The first secret share of the second indicator is computed based on the first secret share of the third indicator.

With reference to the first aspect, in some implementations, each of the N sections of the first l-bit random number includes M bit, where M is a positive integer. The first indicator corresponding xⱼ is generated by: generating, by the first server of the first party, a first random bit as a first secret share of the first indicator; generating, by the first server of the first party based on the first random bit, a group of 2^{M} bits; and sending, to the second server of the second party, a bit selected from the group of 2^{M} bits as a second secret share of the first indicator, where the bit is selected based on yⱼ.

With reference to the first aspect, in some implementations, the method further includes using the Bernoulli sampling of the l-bit random number to generate a random noise value; and adding the random noise value to an MPC computation result according to a differential privacy mechanism before sharing the computation result with one or more other parties.

With reference to the first aspect, in some implementations, using the Bernoulli sampling of the random number to generate a random noise value includes: using the Bernoulli sampling to generate a geometric distribution; using the geometric distribution to generate a discrete Laplacian distribution; using the discrete Laplacian distribution to sample a discrete Gaussian distribution; and using the sampling of the discrete Gaussian distribution to generate the random noise value.

According to a second aspect, a method is provided. The method includes determining a first secret share of a binary integer u of l bits by a first server of a first party of two or more parties participating in a secure multiparty computation (MPC) instance; determining a real number r; receiving a first secret share of a Bernoulli sampling (b′) of 1 bit, where the Bernoulli sampling is computed based on u and r; computing a first secret share of an AND result (v₀) based on u and r; and generating an acceptance bit by performing an equality testing protocol on the first secret share of the AND result and an inversion of a second secret share of the AND result.

With reference to the second aspect, in some implementations, the acceptance bit is zero if any bit of the AND result is zero.

With reference to the second aspect, in some implementations, v₀=¬(u&(¬b′)), where symbol ¬ represents inversion, and symbol & represents AND. Computing the first secret share of the AND result includes: performing, by the first server of the first party participating in the secure MPC instance, an AND operation on the first secret share of b′ and the inversion of the first secret share of u. A second secret share of the AND result is generated by performing, by a second server of a second party participating in the secure MPC instance, an AND operation on a second secret share of b′ and the inversion of a second secret share of u.

With reference to the second aspect, in some implementations, the method further includes determining a sampling probability corresponding to each of the l bits of b′, where the sampling probability is pre-computed based on a corresponding bit of u and r.

With reference to the second aspect, in some implementations, the acceptance bit is in plain text, and the equality testing protocol is based on Oblivious Linear Evaluation (OLE) tuples.

With reference to the second aspect, in some implementations, the method further includes using the acceptance bit in rejection sampling to accept or reject a sample of a discrete Laplacian distribution; if accepted, using the sample of the discrete Laplacian distribution to approximate a sample of a discrete Gaussian distribution; and using acceptance bits for a plurality of samples of the discrete Laplacian distribution to generate a random bit integer used as noise to introduce to secure multiparty computation (MPC) computation results prior to release to other parties to the MPC.

With reference to the second aspect, in some implementations, the method further includes determining, based on the acceptance bit, whether a sampled value is less than a value of the discrete Gaussian distribution at a sampled point of the discrete Laplacian distribution.

With reference to the second aspect, in some implementations, using the acceptance bit in rejection sampling includes: when the acceptance bit has a value of one for a particular sample of the discrete Laplacian distribution, the sample is accepted.

With reference to the second aspect, in some implementations, using the acceptance bit in rejection sampling includes: when the acceptance bit has a value of zero for a particular sample of the discrete Laplacian distribution, the sample is rejected.

With reference to the second aspect, in some implementations, the random bit integer is introduced by a differential privacy mechanism to the MPC computation results.

According to a third aspect, one or more computer-readable storage media is provided. The one or more computer-readable storage media stores one or more instructions that, when executable by one or more computers, cause the one or more computers to perform the method according to the first aspect or one or more implementations of the first aspect, or the second aspect or one or more implementations of the second aspect.

According to a fourth aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect, or the second aspect or one or more implementations of the second aspect.

The subject matter described in this specification can be implemented in particular embodiments so as to realize one or more of the following advantages. Communication costs between parties can be reduced by completing the noise generation in fewer rounds as compared to other techniques. The techniques for generating the acceptance bit can have lower complexity as compared to previous techniques. For example, some techniques require 1 rounds, which has higher round complexity between the two parties, which can further cause latency delays. Additionally, communication complexity, the amount of data sent between the parties during computation, can also be reduced.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example multi-party computation (MPC) system.

FIG. 2 is a flow diagram of an example process for MPC with differential privacy.

FIG. 3 is a diagram of an example pipeline for sampling a discrete Gaussian distribution.

FIG. 4 is a flow diagram of an example process for sampling a Bernoulli distribution.

FIG. 5 is a flow diagram of an example process for sampling an acceptance bit.

FIG. 6 is an example computing system.

Like reference numbers and designations in the various drawings indicate like elements.

### DETAILED DESCRIPTION

MPC techniques allow parties to jointly evaluate a function with their private inputs without sharing those private inputs with the other parties. There are several different techniques that can be used to provide the MPC. Typically, secret sharing is used to provide data privacy. As a simple illustrative example, assume a number of parties working for a company wish to find their average number of countries visited without revealing their own number of countries to any other party. The private data of each participant can be a number representing their number of countries. Each participant divides their number of countries visited into shares, referred to as secret shares. The shares can be random numbers with the constraint being that the combination of some operation on the shares is equal to the private data, i.e., their number of countries in this example. The operation can be, for example, an arithmetic sum or an exclusive OR. For example, using additive shares, if party 1 has visited 10 countries, the shares can be 1, 3, 4, 2, which sum to 10.

If there are four participants, each participant can divide their private data, i.e., number of countries visited, into four shares. The shares are then divided among the parties. Thus, each party has four shares: one of their shares and one share from each other party. By themselves the shares are meaningless random numbers. Each party then combines the values of their shares and reveals that result to the other participants. Each party then has four results, which also provides the total of all the private data values, in other words, the combined private data of all the countries visited. Knowing the total number of countries visited, the parties can then compute a particular function to operate on the information, e.g., divide by four and get the average number of countries visited, without the private information for any individual party being revealed.

While MPC works to provide protection of private data used as input to the functions of the MPC, for some functions it is possible to infer some private data from the generated results based on the nature of the functions being computed. For example, large data sets can include information about many different users. Even with anonymization (e.g., removing names), it is possible to combine outputs generated from the seemingly anonymous data to identify individualized information.

Differential privacy is a technique to reduce the probability of determining individualized private information from the MPC results without changing the outcome of the function being computed. Typically, this is done by applying a particular instance of a differential privacy mechanism that introduces a random noise value to individual data based on some distribution so that there is plausible deniability as to its accuracy, so that no individualized determinations can be made.

In a more general example, two entities may wish to compute functions based on large datasets of information. For example, one entity may be a social media entity with a large dataset of information relating to social media content or users. The second entity may be a content sponsor for the social media entity, an academic institution, or other entity. The social media entity needs to maintain the privacy of their dataset such that individualized information, e.g., about a particular user, cannot be obtained by the second entity. Using MPC, and in particular with differential privacy, allows the two entities to perform data analysis as part of evaluating various functions without providing any access to the private data outside of the respective entities and ensuring within the specified degree of differential privacy that the MPC outputs cannot identify any individualized information.

This specification describes technologies for collaboratively generating shared differential privacy noise in a two-server setting. Specifically, this specification leverages MPC technique to sample random noise according to a discrete Gaussian distribution and outputs the noise in the form of secret sharing.

This specification describes technologies for implementation algorithms used by discrete Gaussian, providing a more efficient implementation of the 2-party protocol, and reducing communication complexity and number of communication rounds.

This specification further describes technologies for providing a distributed sampling protocol for Bernoulli distribution in a two-server setting. This specification further leverages MPC techniques to sample random noise according to a Bernoulli distribution Bₑᵣ(e^{(-u/r)}), where u is an integer number and r is a real number. This protocol avoids complex operations, such as computing the exponential function. Additionally, the protocols and implementations provide data security and privacy against two semi-honest servers.

In some implementations, a direct circuit implementation of Bernoulli distribution [symbol] (p) is to approximately represent p and r in l bits binary form, which includes first sampling r by using l uniform bits, and then performing a comparison between p and r. Assume arithmetic sharing define in the ring [symbol] . However, due to carrying bits in arithmetic operations, the parties, p0 and p1, cannot accurately generate the arithmetic share [r]^{A} of l-bit random numbers, only the exclusive OR share (also referred to as Boolean share) [r]^{B} of l-bit random numbers. The input of the comparison protocol needs to be arithmetic shares. Therefore it is needed to first convert Boolean shares of r to arithmetic shares, and then perform the comparison operation to compare r and p.

This specification further describes new protocols that directly compare Boolean share [r]^{B} and p, which can have the same computational complexity and communication complexity of comparing arithmetic share [r]^{A} and p.

This specification further describes technologies for Bernoulli sampling of acceptance/rejection bits, which can be implemented by converting the sample rejection bits into equality testing results. With this, different equality testing protocols can be used. Furthermore, in some implementations, revealing the acceptance bits does not leak the privacy of the accepted sample since the number of rejection times is independent of the final accepted sample. So, an efficient protocol is designed based on Oblivious Linear Evaluation (OLE) Tuples. In some implementations, this design only needs 2 communication rounds and the total communication of Bernoulli sampling of acceptance/rejection bits is about 4l, where l is the bit length of arithmetic sharing.

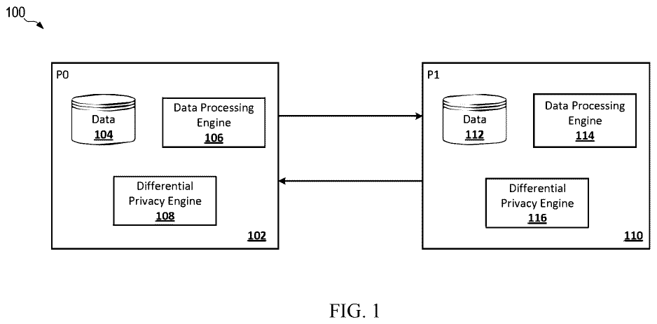

FIG. 1 is a diagram of an example multi-party computation system 100. While in multi-party computation, any suitable number of parties can cooperate, for simplicity the multi-party computation system 100 is illustrated with two parties: a first party 102 and a second party 110. The parties can represent, for example, entities that seek to collaborate on data without revealing private data of either party. One example could be a government agency and a university. The government agency may have a lot of private data, for example, the Census Bureau can have large amounts of private data collected from a population. The university may wish to perform research that includes operations such as statistical analysis performed on a dataset of the Census Bureau.

In a typical MPC scenario, each party jointly computes an agreed-upon function. However, each party only knows the result of the function and their own input. Thus, the first party 102 cannot learn the input of the second party 110. Secret sharing is typically used to evaluate the computation such that each party obtains a share of the output, which when combined reveals the plain output.

Referring to FIG. 1, the first party 102 includes data store 104, a data processing engine 106, and a differential privacy engine 108. Similarly, the second party 110 includes data store 112, data processing engine 114, and differential privacy engine 116. Each party can use their respective data processing engine to perform one or more functions on data from the data store. For example, the data processing engine 106 can perform one or more functions on a dataset from data store 104. The result of the function can be secret shared with the second party 110. However, to provide additional protection from data leakage, the differential privacy engine 108 can apply a differential privacy mechanism to the result prior to sharing. The differential privacy mechanism introduces noise to the result. Adding the random noise to the MPC results can provide a statistically defined degree of differential privacy in the generated results so that the probability of determining any individualized data as part of any party's private data is decreased.

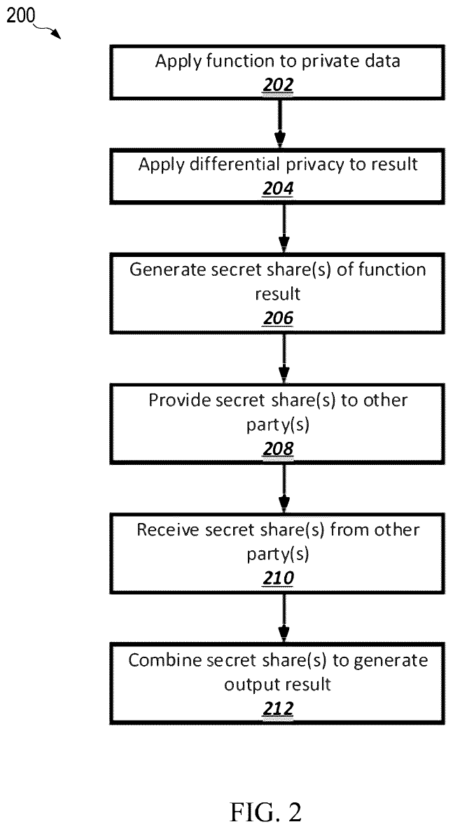

FIG. 2 is a flow diagram of an example process 200 for MPC with differential privacy. For convenience, the process 200 will be described as being performed by a system of one or more computers (e.g., a server), located in one or more locations, and programmed appropriately in accordance with this specification. For example, a multi-party computation system, e.g., the multi-party computation system 100 of FIG. 1, appropriately programmed, can perform the process 200. In particular, the process 200 is described from the perspective of a first party, e.g., a first server, of the multi-party computation system.

The first party applies a function to their private data (202). The first party can include a collection of data that can include private data of various users. The first party can seek to collaborate with one or more other parties, for example, to analyze respective datasets. The first party can apply a corresponding function to their own dataset to generate a first computation result.

The first party applies differential privacy to the first computation result (204). Applying differential privacy to the first computation result can include applying a differential privacy mechanism that has particular differential privacy parameters selected to provide a particular privacy guarantee. The application of the mechanism can include adding noise to the first computation result. The noise can be randomly sampled from a distribution. In some implementations, the noise is randomly sampled from a gaussian distribution. Furthermore, the noise is jointly generated with the other parties, as will be described below.

In some alternative implementations, the parties are sharing the dataset itself rather than a computed result on the dataset. In such cases, rather than applying a function to the data set, the first party instead applies the differential privacy mechanism to the dataset, which is then separated into shares as described below.

The first party generates one or more secret shares of the differentially private result (206). For example, if there are two parties, the first party divides the differentially private result into two shares that can be summed to the differentially private result. The first party retains a share and provides the second share to the second party. If there are more parties, the first parge splits the result into a corresponding number of secret shares so that each party, including the first party, receives one share.

The first party receives a respective secret share from each other party (210). The number of shares received depends on the number of other parties. For example, if there are two parties, the first party receives a single secret share from the second party. If there are four parties, the first party receives three secret shares from three other parties.

The first party combines the received secrets share(s) with their own share to generate a combined output result of the applied function (212). In some implementations, the secret shares are additive such that the sum of the secret shares provides the overall result of the function. The combined secret shares are then shared with the other party so that each party can reconstruct the final differentially private result.

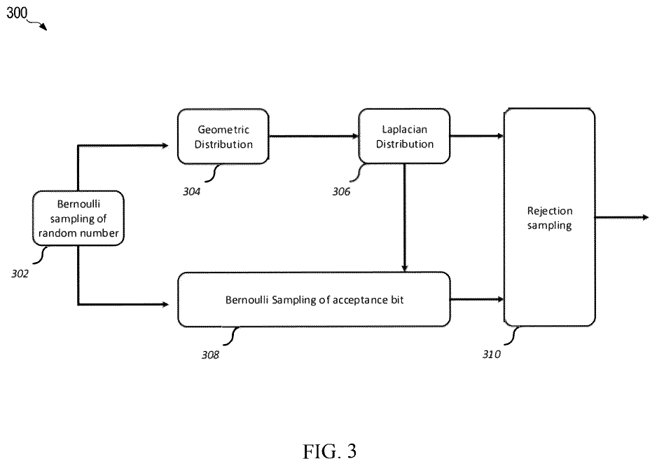

FIG. 3 is a diagram of an example sampling pipeline 300. The sampling pipeline 300 will be described with respect to two parties collaboratively generating a random noise sampled from a discrete Gaussian distribution.

Different types of distributions can be sampled to generate random noise values including Laplacian and Gaussian noise. For example, for a given distribution, the sampling can be used to generate a random sequence of bits each having a value of 0 or 1. Gaussian noise can provide better results under composition, i.e., differential privacy applied to a sequence of queries, due to the lighter tails of the Gaussian distribution. Additionally, noise may be sampled from a continuous or discrete distribution. However, a continuous Gaussian distribution can be computationally costly to sample. A discrete Gaussian distribution can be better represented on finite computers avoiding tricking issues caused by the approximation of continuous noise.

The noise sampling can be performed on a distributed basis, where each party to the MPC provides a portion of the noise, which can then be securely combined, e.g., through secret sharing. The following sampling pipeline 300 allows for sampling discrete Gaussian on a distributed basis. Specifically, the sampling pipeline 300 provides for discrete Gaussian sampling based on rejection sampling, which includes sampling the generated distribution and then determining whether to accept or reject the sample.

The sampling pipeline 300 is presented with a two-party MPC model including a target party and an auxiliary party. Differential privacy is implemented in the MPC model by assuming semi-trusted parties. The target party can choose to publish the differentially private results. The auxiliary party is used with the target party to generate the aggregated differentially private results by applying one or more functions to secret shares of the client private data. In some implementations, one or more client devices divide their raw data into secret shares and then send respective secret shares to the two parties. The two parties run a secret sharing based MPC to compute an aggregate function result based on the respective client shares received. The two parties further use the sampling pipeline 300 to generate noise shares. The pipeline 300 is used to generate a sampling function r=Noise(r₀, r₁)=f(r₀⊕r₁) where r is the discrete Gaussian noise and r1 and r2 are randomized inputs from the respective parties. The symbol ⊕ is the exclusive OR or XOR. The share of r is derived such that the evaluation of a particular logical operator, e.g., XOR, to the shares is equal to r. The logical operator can be a bitwise operation as well as one that can be used for random masking. For example, for two online parties, r is divided into r0 and r1 such that r₀⊕r₁=r. In some alternative implementations, additive sharing is used. For example, for two parties, r is divided into r0 and r1 such that r0+r1=r.

The sampling pipeline 300 is designed to sample a discrete Gaussian distribution based on rejection sampling. Direct sampling from a complicated distribution is avoided by first sampling from a distribution that is easier to sample, which will be referred to as a helper distribution. The samples are then accepted or rejected to make the resulting accepted samples follow a target distribution, e.g., the discrete Gaussian distribution.

For example, suppose [symbol] is a target distribution and [symbol] his a helper distribution. In some implementations, the sampling pipeline 300 chooses the smallest M such that ∀x M· [symbol] (x)≥ [symbol] (x). Then the sampling pipeline 300 proceeds to sample s from [symbol] , then sample bit b from Bernoulli distribution B(f*(s)) to decide whether to accept the sample, where

$${f}_{*} ( x ) = \frac{{f}_{𝒯} ( x )}{M \cdot {f}_{𝒫} ( x )} .$$

That is, the probability to accept s is

$$\frac{{f}_{𝒯} ( x )}{M \cdot {f}_{𝒫} ( x )} .$$

In some implementations, a proposed helper distribution that is similar to the discrete Gaussian distribution, but simpler to sample, can be a discrete Laplacian distribution. A sampling phase then samples from the discrete Laplacian distribution. A sample bit from a Bernoulli distribution is then used to determine whether to accept the sample from the discrete Laplacian distribution. In particular, the acceptance or rejection of a sample depends on whether a sampled value is less than the discrete Gaussian distribution at that point. If so, the sample is accepted. If the sampled value is greater than the discrete Gaussian distribution (but less than the Laplacian distribution), then the sample is rejected. A collection of samples, each represented by a binary one or binary zero can be used to form a random binary number used as differential privacy noise. By having a helper distribution that is similar to the target distribution such that the ratio between values of the two distributions at any point is small, then the probability of acceptance is greater. Bernoulli sampling can be used to generate a Laplacian distribution, as will be described below.

As shown in FIG. 3, the sampling pipeline 300 begins with a sampling of a Bernoulli distribution (302). A Bernoulli distribution is a discrete probability distribution of a random variable which takes the value 1 with probability p and the value 0 with probability q=1−p. A random sampling of the Bernoulli distribution is then used to generate a geometric distribution (304). In particular, a geometric distribution is a probability distribution of the number of Bernoulli trials needed to get one success. The geometric distribution is essentially half of a Laplacian distribution. By adding the negative side of the geometric distribution, a Laplacian distribution can be generated (306). One technique to do this is to sample from the geometric distribution and determine whether the sign should be positive or negative for the sample, e.g., by random assignment. With sufficient samples, the resulting samples form a Laplacian distribution. Other techniques for generating a discrete Laplacian distribution can be used.

With rejection sampling, a Laplace sample can be turned into a Gaussian sample based on the acceptance criteria. This is done by a Bernoulli sampling (308) of an acceptation bit (or a rejection bit) according to the ratio of the Gaussian distribution to the Laplacian distribution, e.g.,

$${B}_{er} = ( \frac{P ( Gaussian )}{P ( Lapacian )} ) .$$

During rejection sampling (310), if the Bernoulli sampling is equal to one, then the sample is inside the Gaussian distribution and the sample is accepted. If the Bernoulli sampling is zero, then the sample is outside of the Gaussian distribution and the sample is rejected.

The following notation may be useful to reference for described techniques for Bernoulli sampling.

| Notation | Meaning |
|---|---|
| l | The bit length of element in the ring [symbol] |
| [symbol] | For arithmetic sharing, an l bits value x is shared |
| | additively in the ring [symbol] |
| [symbol] | For Boolean sharing, 1 bit value x is shared additively |
| | in the ring [symbol] |
| [x]^{A} | The arithmetic sharing of x |
| [x]^{B} | The Boolean sharing of x |
| [x]ᵢ | The secret share belonging to party i |
| 1{b} | The indicator function, which evaluates 1 when b is |
| | true and 0 when b is false |
| s ← S | Denotes sampling an element s, uniformly at random |
| | from S |
| ∥ | The concatenation operation |
| x_{i, j} | The j-th bit of xᵢ |
| [x]^{A} = B2A([x]^{B}) | Converting Boolean secret shares into arithmetic secret |
| | shares |

### Bernoulli Sampling of Random Number

Different techniques can be used to generate the Bernoulli sampling (302), which can then be used to form the geometric distribution (304) and/or generation of an acceptance bit (308). In particular, three variations of a technique for generating the Bernoulli sampling will be described below. The general objective can be the same in each variation. Specifically, since MPC operates on discrete values, an l-bit random number r is generated. The random number r is compared with u=p·2^{l} (rounding to an integer), where p is a particular probability selected for the Bernoulli sampling and l is the bit length that converts the probability p to a fixed number. For example, for an MPC implementation operating on 264 bit ring ( [symbol] ) and when the probability for the sampling is p=0.3, then a random 64-bit binary number can be generated and compared with u=0.3 (264), rounding to an integer. Based on the comparison between rand u, the result of the sample is either 0 or 1.

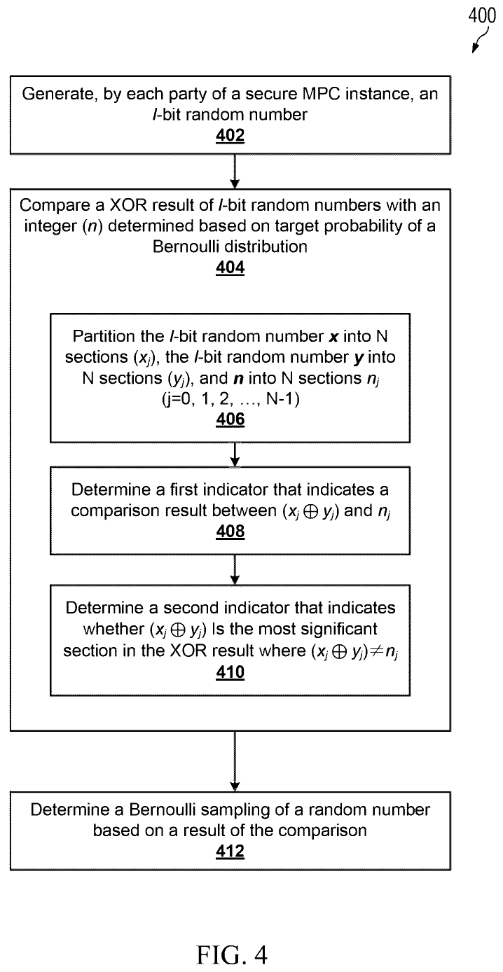

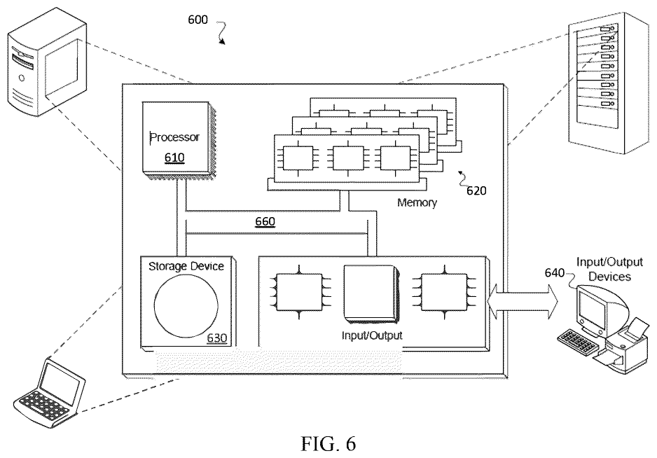

FIG. 4 is a flow diagram of an example process 400 for performing Bernoulli sampling. The operations shown in process 400 may not be exhaustive and that other operations can be performed as well before, after, or in between any of the illustrated operations. Further, some of the operations may be performed simultaneously, or in a different order than shown in FIG. 4. For convenience, the process 400 will be described as being performed by a system of one or more computers (e.g., a server implemented by a computer system 600 of FIG. 6), located in one or more locations, and programmed appropriately in accordance with this specification. For example, a multi-party computation system, e.g., the multi-party computation system 100 of FIG. 1, appropriately programmed, can perform the process 400. In particular, the process 400 is described from the perspective of a first party, e.g., a first server, of the multi-party computation system.

Parties of the MPC can collectively generate an l-bit random number r based on the MPC implementation, e.g., secret sharing (402). For example, in a two party setting, the first party can generate an l-bit random number r₀, and the second party can generate an l-bit random number r₁, so that r₀⊕r₁=r is also an l-bit random number.

A XOR result of the l-bit random numbers generated by each party is then compared with an integer (e.g., u=[2^{l}·p] in Algorithms 1-3) determined based on a target probability (e.g., p) of a Bernoulli distribution (404). A comparison protocol (e.g., shown in steps 4-30 of Algorithm 1, steps 4-33 of Algorithm 2, or steps 4-25 of Algorithm 3) can be performed on r₀⊕r₁ and u based on oblivious transfer. The goal of the comparison is to determine whether to output a binary 1 or 0 as the result of the Bernoulli sample.

Specifically, x=r₀ and y=r₁ can each be partitioned into N sections (each section include m bits). The integer n can also be partitioned into N sections (406). For each section, a first indicator (e.g., [ltⱼ]^{B}) can be generated to indicate a comparison result between (xⱼ⊕yⱼ) and uⱼ, where xⱼ is the jth section of x, yⱼ is the jth section of y, and where uⱼ is the jth section of u (408). For each section, a second indicator (e.g., [sⱼ]^{B}) can be generated to indicate whether the section is the most significant section in xⱼ⊕yⱼ where (xⱼ⊕yⱼ)≠uⱼ (410). The comparison result can be determined based on first indicator and second indicators corresponding to the N sections.

In some implementations, for each section, the first party receives a first secret share of the first indicator

$$( e . g . , {[ {lt}_{j} ]}_{0}^{B} )$$

and a first secret share of the second indicator

$$( e . g . , {[ {s}_{j} ]}_{0}^{B} ) ,$$

and the second party receives a second secret share of the first indicator

$$( e . g . , {[ {lt}_{j} ]}_{1}^{B} )$$

and a second secret share of the second indicator

$$( e . g . , {[ {s}_{j} ]}_{1}^{B} ) .$$

In some implementations, the first indicator can be generated based on oblivious transfer. The first party can generate a first random bit as the first secret share of the first indicator

$$( e . g . , {[ {lt}_{j} ]}_{1}^{B} ) ← \{ 0 , 1 \} in Alogrithm 1 or 2.$$

The first party generates a grout of a group of 2^{M} bits

$$( e . g . , {s}_{j , k} = {[ {lt}_{j} ]}_{0}^{B} ⊕ 1 \{ ( {x}_{j} ⊕ k ) < {u}_{j} \} , k \{ 0 , 1 , , M - 1 \} , where M = {2}^{m} in Alogrithm 1 or 2 )$$

based on the first random bit. A bit

$$( e . g . , {s}_{j , {y}_{j}} = {[ {lt}_{j} ]}_{0}^{B} ⊕ 1 \{ ( {x}_{j} ⊕ {y}_{j} ) < {u}_{j} \} in Algorithm 1 or 2 )$$

selected from the group of 2^{M} bits is sent to the second party as a second secret share of the first indicator, wherein the bit is selected based on yⱼ.

In some implementations, the first indicator is generated based on a third indicator (e.g., [eqⱼ]^{B} of algorithm 1 or [eqⱼ]^{A} of algorithm 2) that indicates whether xⱼ⊕yⱼ=uⱼ. The first party receives a first secret share

$$( e . g . , {[ {eq}_{j} ]}_{0}^{B} in algorthm 1 , {or [ {eq}_{j} ]}_{0}^{A} in algorthm 2 )$$

of the third indicator, and generates the first secret share of the first indicator based on the first secret share of the third indicator

$$( e . g . , {[ {s}_{j} ]}_{0}^{A} = ( {\sum }_{k = 0}^{j} {[ {eq}_{k} ]}_{0}^{A} - 2 \cdot {[ {eq}_{j} ]}_{0}^{A} + 1 ) mod ( q + 1 ) in algorithm 1 or 2 )$$

The second party receives a second secret share

$$( e . g . , {[ {eq}_{j} ]}_{1}^{B} in algorthm 1 , {or [ {eq}_{j} ]}_{1}^{A} in algorthm )$$

of the third indicator, and generates the second secret share of the first indicator based on the second secret share of the third indicator

$$( e . g . , {[ {s}_{j} ]}_{1}^{A} = ( {\sum }_{k = 0}^{j} {[ {eq}_{k} ]}_{1}^{A} - 2 \cdot {[ {eq}_{j} ]}_{1}^{A} ) mod ( q + 1 ) in algorithm 1 or 2 ) .$$

A Bernoulli sampling of a random integer (e.g., b) can be determined based on a result of the comparison (412). In some implementations, the Bernoulli sampling of a random integer can be in the form of secret shares [b]^{B}, for example,

$${[ b ]}_{0}^{B} = {\sum }_{j = 0}^{j = q - 1} {[ {g}_{j} ]}_{0}^{B} ⊕ {[ {h}_{j} ]}_{0}^{B} {and [ b ]}_{1}^{B} = {\sum }_{j = 0}^{j = q - 1} {[ {g}_{j} ]}_{1}^{B} ⊕ {[ {h}_{j} ]}_{1}^{B} ,$$

as shown in Algorithms 1-2, or

$${[ b ]}_{0}^{B} = {[ {lt}_{log ( q ) , 0 )} ]}_{0}^{B} {and [ b ]}_{1}^{B} = {[ {lt}_{log ( q ) , 0 )} ]}_{1}^{B}$$

as shown in Algorithm 3.

Each of Algorithms 1-3 describes a particular process for generating r and comparing r and u using a comparison protocol based on Oblivious Transfer (OT).

Algorithm 1:
Input: SamplingBernoulli^{B}(p).
Output: Sample x of Bernoulli distribution [symbol] (p).

| | |
|---|---|
| 1. | P₀ and P₁ locally compute u = ┌2^{l} · p┘ |
| 2. | P₀ randomly generates l bits, denoted as rₒ |
| 3. | P₁ randomly generates l bits, denoted as rₗ |
| 4. | P₀ and P₁ set x₀ = r₀ and y₀ = r₁, respectively. |
| 5. | P₀ and P₁ parses u as u = u_{q-1}∥ . . . ∥u₀, respectively. |
| 6. | P₀ parses its input as x = x_{q-1}∥ . . . ∥x₀ and P₁ parses its input as y = y_{q-1}∥ . . . ∥y₀, |
| | where xⱼ, yⱼ ∈ {0, 1}^{m}, q = ┌l/m┐, the bit lengths of x and y are equal, denoted by 1. |
| 7. | Let M = 2^{m}. |
| 8. | for j = {0, 1, . . . , q − 1} do |
| 9. | ${P}_{0} {samples [ {lt}_{j} ]}_{0}^{B} , {[ {eq}_{j} ]}_{0}^{B} ← \{ 0 , 1 \}$ |
| 10. | for k = {0, 1, . . . , M − 1} do |
| 11. | ${P}_{0} sets {s}_{j , k} = {[ {lt}_{j} ]}_{0}^{B} ⊕ 1 \{ ( {x}_{j} ⊕ k ) < {u}_{j} \}$ |
| 12. | ${P}_{0} sets {t}_{j , k} = {[ {eq}_{j} ]}_{0}^{B} ⊕ 1 \{ ( {x}_{j} ⊕ k ) \neq {u}_{j} \}$ |
| 13. | end for |
| 14. | P₀ and P₁ invoke an instance of 1 out of M oblivious transfer (OT), where P₀ is the |
| | $sender with inputs {\{ {s}_{j , k} \}}_{k} and {P}_{1} is the receiver with input {y}_{j} . {P}_{1} sets its output {as [ {lt}_{j} ]}_{1}^{B}$ |
| 15. | P₀ and P₁ invoke an instance of 1 out of M OT, where P₀ is the sender with inputs |
| | ${\{ {t}_{j , k} \}}_{k} and {P}_{1} is the receiver with input {y}_{j} . {P}_{1} sets its output {as [ {eq}_{j} ]}_{1}^{B}$ |
| 16. | end for |
| 17. | for j = {0, 1, . . . , q − 1} do |
| 18. | ${P}_{0} {samples [ {eq}_{j} ]}_{0}^{A} ← \{ 0 , 1 , ... q \}$ |
| 19. | for k = {0, 1} do |
| 20. | ${P}_{0} sets {t}_{j , k} = ( 1 \{ {[ {eq}_{j} ]}_{0}^{B} \neq k \} - {[ {eq}_{j} ]}_{0}^{A} ) mod ( q + 1 )$ |
| 21. | end for |
| 22. | P₀ and P₁ invoke an instance of 1 out of 2 OT where P₀ is the sender with inputs |
| | ${\{ {t}_{j , k} \}}_{k} and {P}_{1} is the receiver with {input [ {eq}_{j} ]}_{1}^{B} . {P}_{1} sets its output {as [ {eq}_{j} ]}_{1}^{A}$ |
| 23. | ${P}_{0} and {P}_{1} {compute [ {s}_{j} ]}_{0}^{A} = ( {\sum }_{k = 0}^{j} {[ {eq}_{k} ]}_{0}^{A} - 2 \cdot {[ {eq}_{j} ]}_{0}^{A} + 1 ) mod ( q + 1 ) and$ |
| | ${[ {s}_{j} ]}_{1}^{A} = ( {\sum }_{k = 0}^{j} {[ {eq}_{k} ]}_{1}^{A} - 2 \cdot {[ {eq}_{j} ]}_{1}^{A} ) mod ( q + 1 ) , respectively .$ |
| 24. | end for |
| 25. | for j = {0, 1, . . . , q − 1} do |
| 26. | ${P}_{0} {samples [ {g}_{j} ]}_{0}^{B} ← \{ 0 , 1 \}$ |
| 27. | for k = {0, 1, . . . , q} do |
| 28. | ${P}_{0} sets {t}_{j , k} = {[ {g}_{j} ]}_{0}^{B} ⊕ 1 \{ {[ {s}_{j} ]}_{0}^{A} = k \} ∧ {[ {lt}_{j} ]}_{0}^{B}$ |
| 29. | end for |
| 30. | P₀ and P₁ invoke an instance of 1 out of (q + 1) OT where P₀ is the sender with |
| | $inputs {\{ {t}_{j , k} \}}_{k} and {P}_{1} is the receiver with input - {[ {s}_{j} ]}_{0}^{A} . {P}_{1} sets its output {as [ {g}_{j} ]}_{1}^{B}$ |
| 31. | end for |
| 32. | for j = {0, 1, . . . , q − 1} do |
| 33. | ${P}_{1} {samples [ {h}_{j} ]}_{1}^{B} ← \{ 0 , 1 \}$ |
| 34. | for k = {0, 1, . . . , q} do |
| 35. | ${P}_{1} sets {t}_{j , k} = {[ {h}_{j} ]}_{1}^{B} ⊕ 1 \{ {[ {s}_{j} ]}_{1}^{A} = k \} ∧ {[ {lt}_{j} ]}_{1}^{B}$ |
| 36. | end for |
| 37. | P₀ and P₁ invoke an instance of 1 out of (q + 1) OT where P₁ is the sender with |
| | $inputs {\{ {t}_{j , k} \}}_{k} and {P}_{0} is the receiver with input - {[ {s}_{j} ]}_{0}^{A} . {P}_{0} sets its output {as [ {h}_{j} ]}_{0}^{B}$ |
| 38. | end for |
| 39. | ${P}_{0} and {P}_{1} set their output as {\sum }_{j = 0}^{j = q - 1} {[ {g}_{j} ]}_{0}^{B} ⊕ {[ {h}_{j} ]}_{0}^{B} mod 2 and {\sum }_{j = 0}^{j = q - 1} {[ {g}_{j} ]}_{1}^{B} ⊕ {[ {h}_{j} ]}_{1}^{B} mod$ |
| | 2, respectively. |

Algorithm 2:
Input: : SamplingBernoulli^{B}(p).
Output: Sample x of Bernoulli distribution [symbol] (p).

| | |
|---|---|
| 1. | P₀ and P₁ locally compute u = ┌2^{l} · p┘ |
| 2. | P₀ randomly generates l bits, denoted as rₒ |
| 3. | P₁ randomly generates l bits, denoted as rₗ |
| 4. | P₀ and P₁ set x₀ = r₀ and y₀ = r₁, respectively. |
| 5. | P₀ and P₁ parses u as u = u_{q-1}∥ . . . ∥u₀, respectively. |
| 6. | P₀ parses its input as x = x_{q-1}∥ . . . ∥x₀, and P₁ parses its input as y = y_{q-1}∥ . . . ∥y₀, where |
| | xⱼ, yⱼ ∈ {0, 1}^{m}, q = ┌l/m┘, the bit lengths of x and y are equal, denoted by l. |
| 7. | Let M = 2^{m}. |
| 8. | for j = {0, 1, . . . , q − 1} do |
| 9. | ${P}_{0} {samples [ {lt}_{j} ]}_{0}^{B} ← \{ 0 , 1 \}$ |
| 10. | ${P}_{0} {samples [ {eq}_{j} ]}_{0}^{B} ← \{ 0 , 1 , ... , q \}$ |
| 11. | for k = {0, 1, . . . , M − 1} do |
| 12. | ${P}_{0} sets {s}_{j , k} = {[ {lt}_{j} ]}_{0}^{B} ⊕ 1 \{ ( {x}_{j} ⊕ k ) < {u}_{j} \}$ |
| 13. | ${P}_{0} sets {t}_{j , k} = ( 1 \{ ( {x}_{j} ⊕ k ) \neq {u}_{j} \} - {[ {eq}_{j} ]}_{0}^{A} ) mod ( q + 1 )$ |
| 14. | end for |
| 15. | P₀ and P₁ invoke an instance of 1 out of M OT where P₀ is the sender with inputs |
| | ${\{ {s}_{j , k} \}}_{k} and {P}_{1} is the receiver with input {y}_{j} . {P}_{1} sets its output {as [ {lt}_{j} ]}_{1}^{B}$ |
| 16. | P₀ and P₁ invoke an instance of 1 out of M OT where P₀ is the sender with inputs |
| | ${\{ {t}_{j , k} \}}_{k} and {P}_{1} is the receiver with input {y}_{j} . {P}_{1} sets its output {as [ {eq}_{j} ]}_{1}^{A}$ |
| 17. | ${P}_{0} and {P}_{1} {compute [ {s}_{j} ]}_{0}^{A} = ( {\sum }_{k = 0}^{j} {[ {eq}_{k} ]}_{0}^{A} - 2 \cdot {[ {eq}_{j} ]}_{0}^{A} + 1 ) mod ( q + 1 ) and$ |
| | ${[ {s}_{j} ]}_{1}^{A} = ( {\sum }_{k = 0}^{j} {[ {eq}_{k} ]}_{1}^{A} - 2 \cdot {[ {eq}_{j} ]}_{1}^{A} ) mod ( q + 1 ) , respectively .$ |
| 18. | end for |
| 19. | for j = {0, 1, . . . , q − 1} do |
| 20. | ${P}_{0} {samples [ {g}_{j} ]}_{0}^{B} ← \{ 0 , 1 \}$ |
| 21. | for k = {0, 1, . . . , q} do |
| 22. | ${P}_{0} sets {t}_{j , k} = {[ {g}_{j} ]}_{0}^{B} ⊕ 1 \{ {[ {s}_{j} ]}_{0}^{A} = k \} ∧ {[ {lt}_{j} ]}_{0}^{B}$ |
| 23. | end for |
| 24. | P₀ and P₁ invoke an instance of 1 out of (q + 1) OT where P₀ is the sender with |
| | $inputs {\{ {t}_{j , k} \}}_{k} and {P}_{1} is the receiver with input - {[ {s}_{j} ]}_{0}^{A} . {P}_{1} sets its output {as [ {g}_{j} ]}_{1}^{B}$ |
| 25. | end for |
| 26. | for j = {0, 1, . . . , q − 1} do |
| 27. | ${P}_{1} {samples [ {h}_{j} ]}_{1}^{B} ← \{ 0 , 1 \}$ |
| 28. | for k = {0, 1, . . . , q} do |
| 29. | ${P}_{1} sets {t}_{j , k} = {[ {h}_{j} ]}_{1}^{B} ⊕ 1 \{ {[ {s}_{j} ]}_{1}^{A} = k \} ∧ {[ {lt}_{j} ]}_{1}^{B}$ |
| 30. | end for |
| 31. | P₀ and P₁ invoke an instance of 1 out of (q + 1) OT where P₁ is the sender with |
| | $inputs {\{ {t}_{j , k} \}}_{k} and {P}_{0} is the receiver with input - {[ {s}_{j} ]}_{0}^{A} . {P}_{0} sets its output {as [ {h}_{j} ]}_{0}^{B}$ |
| 32. | end for |
| 33. | ${P}_{0} and {P}_{1} set their output as {\sum }_{j = 0}^{j = q - 1} {[ {g}_{j} ]}_{0}^{B} ⊕ {[ {h}_{j} ]}_{0}^{B} mod 2 and {\sum }_{j = 0}^{j = q - 1} {[ {g}_{j} ]}_{1}^{B} ⊕ {[ {h}_{j} ]}_{1}^{B} mod 2 ,$ |
| | respectively. |

Algorithm 3
Input: : SamplingBernoulli^{B}(p).
Output: Sample x of Bernoulli distribution [symbol] (p).

| | |
|---|---|
| 1. | P₀ and P₁ locally compute u = ┌2^{l} · p┘ |
| 2. | P₀ randomly generates l bits, denoted as rₒ |
| 3. | P₁ randomly generates l bits, denoted as rₗ |
| 4. | P₀ and P₁ set x₀ = r₀ and y₀ = r₁, respectively. |
| 5. | P₀ and P₁ parses u as u = u_{q-1}∥ . . . ∥u₀, respectively. |
| 6. | P₀ parses its input as x = x_{q-1}∥ . . . ∥x₀, and P₁ parses its input as y = y_{q-1}∥ . . . ∥y₀, where xⱼ, |
| | yⱼ ∈ {0, 1}^{m}, q = ┌l/m┘, the bit lengths of x and y are equal, denoted by l. |
| 7. | Let M = 2^{m}. |
| 8. | for j = {0, 1, . . . , q − 1} do |
| 9. | ${P}_{0} {samples [ {lt}_{0 , j} ]}_{0}^{B} ← \{ 0 , 1 \}$ |
| 10. | ${P}_{0} {samples [ {eq}_{0 , j} ]}_{0}^{B} ← \{ 0 , 1 \}$ |
| 11. | for k = {0, 1, . . . , M − 1} do |
| 12. | ${P}_{0} sets {s}_{j , k} = {[ l {t}_{0 , j} ]}_{0}^{B} ⊕ 1 \{ ( {x}_{j} ⊕ k ) < {u}_{j} \}$ |
| 13. | ${P}_{0} sets {t}_{j , k} = {[ e {q}_{0 , j} ]}_{0}^{B} ⊕ 1 \{ ( {x}_{j} ⊕ k ) \neq {u}_{j} \}$ |
| 14. | end for |
| 15. | P₀ and P₁ invoke an instance of 1 out of M OT where P₀ is the sender with inputs |
| | ${\{ {s}_{j , k} \}}_{k} and {P}_{1} is the receiver with input {y}_{j} . {P}_{1} sets its output {as [ {lt}_{0 , j} ]}_{1}^{B}$ |
| 16. | P₀ and P₁ invoke an instance of 1 out of M OT where P₀ is the sender with inputs |
| | ${\{ {t}_{j , k} \}}_{k} and {P}_{1} is the receiver with input {y}_{j} . {P}_{1} sets its output {as [ {eq}_{0 , j} ]}_{1}^{B}$ |
| 17. | end for |
| 18. | for i = {1, . . . , log(q)} do |
| 19. | for j = {0, . . . , (q/2ⁱ) − 1} do |
| 20. | $for b ∈ \{ 0 , 1 \} , Party b invokes AND with {inputs [ {lt}_{i - 1 , 2 j} ]}_{b}^{B} and$ |
| | ${[ l {t}_{i - 1 , 2 j + 1} ]}_{b}^{B} to learn {output [ temp ]}_{b}^{B} .$ |
| 21. | $for b ∈ \{ 0 , 1 \} , Party b {sets [ {lt}_{l , j} ]}_{b}^{B} = {[ l {t}_{i - 1 , 2 j + 1} ]}_{b}^{B} ⊕ {[ t e m p ]}_{b}^{B}$ |
| 22. | $for b ∈ \{ 0 , 1 \} , Party b invokes AND with {inputs [ {eq}_{i - 1 , 2 j} ]}_{b}^{B} and$ |
| | ${[ e {q}_{i - 1 , 2 j + 1} ]}_{b}^{B} to learn {output [ {eq}_{i , j} ]}_{b}^{B} .$ |
| 23. | end for |
| 24. | end for |
| 25. | $For b ∈ \{ 0 , 1 \} , Party b {outputs [ b ]}^{B} = {[ l {t}_{log ( q ) , 0 )} ]}_{b}^{B}$ |

### Sampling Binomial Distribution

Different techniques can be used to generate samples following a binomial distribution. Algorithm 4 described below is an example technique for sampling the binomial distribution. For example, the binomial distribution can be sampled based on Bernoulli sampling (e.g., using one of the example Algorithms 1-3 of SamplingBernoulli^{B}(p) described above). In some implementations, additional or different algorithms can be used.

Algorithm 4: SamplingBinomial^{A}(n, p)
Input: parameters n and p of Binomial distribution
Output: [x]^{A}, where xis a random sample following Binomial(n, p)

| 1. | For i ← {1, 2, 3, . . . , n } | |
|---|---|---|
| | a. | [rᵢ]^{B} = SamplingBernoulli^{B}(p) |
| 2. | End For | |
| 3. | For i ← {1, 2, 3, . . . , n } | |
| | a. | [rᵢ]^{A} = B2A([rᵢ]^{B}) |

| | |
|---|---|
| 4. | End For |
| 5. | Party 0 get the output by locally summing up |
| | ${[ {r}_{i} ]}_{0}^{A} {: [ x ]}_{0}^{A} = {\sum }_{i = 1}^{i = n} {[ {r}_{i} ]}_{0}^{A}$ |
| 6. | Party 1 get the output by locally summing up |
| | ${[ {r}_{i} ]}_{1}^{A} {: [ x ]}_{1}^{A} = {\sum }_{i = 1}^{i = n} {[ {r}_{i} ]}_{1}^{A}$ |

### Sampling Geometric Distribution

Different techniques can be used to generate samples following the geometric distribution (304). Algorithm 5 described below is an example technique for sampling the geometric distribution. For example, the geometric distribution can be sampled based on Bernoulli sampling (e.g., using one of the example Algorithms 1-3 of SamplingBernoulli^{B}(p) described above). In some implementations, additional or different algorithms can be used.

$Algorithm 5 : {SamplingGeometric}_{N}^{A} ( p )$
Input: parameters p of Geometric distribution, and range parameter
N = 2^{k}
$Output {: [ x ]}^{A} , where x is a random sample following {Geometric}_{N}^{A} ( p ) .$
Precompute: pᵢ = p²^{ⁱ}/(1 + p²^{ⁱ}) for i = 0, . . . , k − 1

| 1. | For i ← 0 to k − 1 do | |
|---|---|---|
| | a. | [rᵢ]^{B} = SamplingBernoulli^{B}(pᵢ) |

| | |
|---|---|
| 2. | End For |
| 3. | [x]^{A} = B2A([rₖ₋₁]^{B}∥[rₖ₋₂]^{B}∥. . . ∥[r₀]^{B}) |

### Sampling Discrete Laplace Distribution

Different techniques can be used to generate samples following the Laplace distribution (306). Algorithm 6 described below is an example technique for sampling the Laplace distribution, for example, based on a geometric distribution. As an example, the Laplace distribution can be sampled based on the geometric distribution sampling (e.g., using the example Algorithm 5 of

$$SamplingGeomet {ric}_{N}^{A} ( p )$$

described above). In some implementations, additional or different algorithms can be used. For example, Algorithm 6 also uses the Bernoulli sampling (e.g., using one of the example Algorithms 1-3 of SamplingBernoulli^{B}(pᵢ) described above) to generate a random number.

```
  $Algorithm 6 : {SamplingLaplace}_{ℤ , N}^{A} ( t )$
  Input: parameterstof Discrete Laplace distribution, and range
parameter N = 2^{k} + 1
  $\begin{matrix}Output {: [ x ]}^{A} {and [ \vert x \vert ]}^{A} , where x is a random sample \\ following {Laplace}_{ℤ , N}^{A} ( p ) .\end{matrix}$
  Precompute: p = e^{-1/t}, p₀ = [symbol]  (0, t)
```

| | |
|---|---|
| 1. | [b]^{B} = SamplingBernoulli^{B}(p₀) |
| 2. | ${[ x ]}^{B} = {SampleGeometric}_{N - 1}^{B} ( p )$ |
| 3. | [x]^{A} = B2A([x]^{B}), which converts the Boolean share of x into the |

arithmetic share of x.

| | |
|---|---|
| 4. | P₀ and P₁ randomly generate one bit [s]₀ and [s]₁, respectively. |
| 5. | [v]^{A} = MUX([b]^{B}, 0, [x]^{A} + 1), where [v]^{A} = 0 if [b]^{B} = 0, |

[v]^{A} = [x]^{A} + 1 if [b]^{B} = 1.

| | |
|---|---|
| 6. | [x]^{A} = MUX([s]^{B}, [v]^{A}, [−v]^{A}), where [x]^{A} = [v]^{A} if [s]^{B} = 0, |

[x]^{A} = [−v]^{A} if [s]^{B} = 1.

| | |
|---|---|
| 6. | [\|x\|]^{A} = [v]^{A} |

### Sampling of Acceptance Bit

Different techniques can be also used to generate the acceptance bit (308), for example, based on Bernoulli sampling. Algorithms 7 and 8 described below are example techniques for generating an acceptance bit following Bernoulli sampling Bₑᵣ(e^{(-u/r)}, which has a probability of e^{(-u/r)}. The reason for this format is that this matches the format used for rejection sampling for a discrete Gaussian distribution in the example process 300. Thus, the Bernoulli sampling format in Algorithms 7 and 8 is specifically designed for sampling the acceptance bit in the example process 300. The input parameters u and r can be obtained, for example, based on Algorithm 12 described below. In some implementations, the parameters and formats of the algorithms can be adjusted accordingly based on different implementations.

As an example, the acceptance bit can be sampled using either Algorithm 7 or 8 based on the Bernoulli sampling (e.g., according to one of the example Algorithms 1-3 of SamplingBernoulli^{B}(p) described above). In some implementations, additional or different algorithms can be used.

$Algorithm 7 : {SamplingBernoulli}_{exp}^{B} ( u , r )$
$Input : {Integer [ u ]}^{B} = {\sum }_{i = 0}^{l - 1} {u}_{i} {2}^{i} with {u}_{i} ∈ \{ 0 , 1 \} , r > 0$
Output: [b]^{B}, where b is a random sample following
Bernoulli(exp(−u/r)).
Precompute: pᵢ = exp(−2ⁱ/r) for i = 0, . . . , l − 1

| | |
|---|---|
| 1. | For i ← 0 to l − 1 do |
| | a. [bᵢ′]^{B} = SamplingBernoulli^{B}(pᵢ) |
| 2. | End For |
| 3. | [v₀]^{B} = ¬([u]^{B} & (¬[b′]^{B})) |
| 4. | Set [v₀]^{B} = [v_{0,l-1}]^{B} ∥ [v_{0,l-2}]^{B} ∥. . .∥ [v_{0,0}]^{B} |
| 5. | For k = {1, . . . , log(l)} do |
| 6. | For j = {0, . . . , (l/2^{k}) − do |
| 7. | $\begin{matrix}For b ∈ \{ 0 , 1 \} , Party b invokes AND with inputs \\ {[ {v}_{k - 1 , 2 j} ]}_{b}^{B} and {[ {v}_{k - 1 , 2 j + 1} ]}_{b}^{B} to learn {output [ {v}_{k , j} ]}_{b}^{B} .\end{matrix}$ |

${[ {v}_{k - 1 , 2 j + 1} ]}_{b}^{B} to learn {output [ {v}_{k , j} ]}_{b}^{B} .$

| | |
|---|---|
| 8. | End For |
| 9. | End For |
| 10. | $For i ∈ \{ 0 , 1 \} , Party i {outputs [ b ]}^{B} = {[ {v}_{log ( l ) , 0} ]}_{b}^{B}$ |

$Algorithm 8 : {SamplingBernoulli}_{exp}^{B} ( u , r )$
$Input : {Integer [ u ]}^{B} = {\sum }_{i = 0}^{l - 1} {u}_{i} {2}^{i} with {u}_{i} ∈ \{ 0 , 1 \} , r > 0$
Output: [b]^{B}, where b is a random sample following Bernoulli(exp(−u/r)).
Precompute: pᵢ = exp(−2ⁱ/r) for i = 0, . . . , l − 1

| | |
|---|---|
| 1. | For i ← 0 to l − 1 do |
| | a. [bᵢ′]^{B} = SamplingBernoulli^{B}(pᵢ) |
| 2. | End For |
| 3. | [v]^{B} = ¬([u]^{B} & (¬[b′]^{B})) |
| 4. | ${[ b ]}^{B} = SecureEquality ( {[ v ]}_{0}^{B} , ¬ {[ v ]}_{1}^{B} )$ |

In some implementations, as shown in Algorithm 8, the sampling of the acceptance bit can be converted into equality testing between a first secret share of an AND result and a second secret share of the AND result, where the AND result is ¬([u]^{B}&(¬[b′]^{B})), where [u]^{B} is an l-bit Bernoulli sample (in the form of secret shares) and [b′]^{B} is an l-bit number (in the form of secret shares) associated with a target probability of a Bernoulli distribution. Different equality testing protocols can be used. For example, either of Algorithms 9 or 10 can be used if the final result is secret sharing. In some implementations, if the final result is plaintext, Algorithm 11 can be used, for example, in scenarios where revealing the acceptance bits does not leak the privacy of the accepted sample since the number of reject times is independent of the final accepted sample. As shown in Algorithm 11, the equality testing protocol can be designed based on OLE Tuples. It only needs 2 communication rounds and the total communication is about 4l, where l is the bit length of arithmetic sharing.

```
  Algorithm 9: SecureEquality(x₀, y₀)
  Input: P₀ holds x₀; P₁ holds y₀.
  Output: P₀, P₁ learn [1{x₀ = y₀}]^{B}.
```

| 1. | P₀ and P₁ set i = 0. | |
|---|---|---|
| 2. | do | |
| | a. | P₀ parses its input as xᵢ = x_{i,q}_{ᵢ}₋₁∥. . .∥x_{i,0} and P₁ parses its |

input as yᵢ = y_{i,q}_{ᵢ}₋₁∥. . .∥y_{i,o}, where x_{i,j}, y_{i,j} ∈ {0, 1}^{m}^{ᵢ}, qᵢ = ┌lᵢ/mᵢ┐, the
bit lengths of xᵢ and yᵢ are equal, denoted by lᵢ.

| | |
|---|---|
| b. | Let Mᵢ = 2^{m}^{ᵢ}. |
| c. | for j = {0, 1, . . . , qᵢ − 1} do |
| d. | ${P}_{0} {samples [ {eq}_{i , j} ]}_{0}^{B} ← \{ 0 , 1 \}$ |
| e. | for k = {0, 1, . . . , Mᵢ − 1} do |
| f. | if qᵢ > 1 |
| g. | ${P}_{0} sets {t}_{i , j , k} = {[ e {q}_{i , j} ]}_{0}^{B} ⊕ 1 \{ {x}_{i , j} \neq k \}$ |
| h. | else |
| i. | ${P}_{0} sets {t}_{i , j , k} = {[ e {q}_{i , j} ]}_{0}^{B} ⊕ 1 \{ {x}_{i , j} = k \}$ |
| j. | end if |
| k. | end for |
| l. | P₀ and P₁ invoke an instance of 1 out of Mᵢ OT where P₀ |

$\begin{matrix}is the sender with inputs {\{ {t}_{i , j , k} \}}_{k} and {P}_{1} is the receiver \\ with input {y}_{i , j} . {P}_{1} sets its output {as [ {eq}_{i , j} ]}_{1}^{B} .\end{matrix}$

| | |
|---|---|
| m. | end for |
| n. | P₀ and P₁ compute i = i + 1. |
| o. | ${P}_{0} and {P}_{1} set {x}_{i} = {[ e {q}_{i - 1 , 0} ]}_{0}^{B} {‖ … ‖ [ {eq}_{i - 1 , {q}_{i - 1} - 1} ]}_{0}^{B}$ |

$and {y}_{i} = {[ {eq}_{i - 1 , 0} ]}_{1}^{B} {‖ … ‖ [ {eq}_{i - 1 , {q}_{i - 1} - 1} ]}_{1}^{B} , respectively .$

| | |
|---|---|
| 3. | while qᵢ₋₁ > 1. |
| 4. | ${P}_{0} and {P}_{1} set their output {as [ {eq}_{i - 1 , 0} ]}_{0}^{B} {and [ {eq}_{i - 1 , 0} ]}_{1}^{B} ,$ |
| | respectively. |

```
  Algorithm 10: SecureEquality(x, y)
  Input: P₀ holds x; P₁ holds y.
  Output: P₀, P₁ learn [1{x = y}]^{B}.
```

| | |
|---|---|
| 1. | P₀ parses its input as x = x_{q-1}∥. . .∥x₀ and P₁ parses its |

input as y = y_{q-1}∥. . .∥y₀, where xⱼ, yⱼ ∈ {0, 1}^{m}, q = ┌l/m┐, the bit
lengths of x and y are equal, denoted by l.

| | |
|---|---|
| 2. | Let M = 2^{m}. |
| 3. | for j = {0, 1, . . . , q − 1} do |
| 4. | ${P}_{0} {samples [ {eq}_{i , j} ]}_{0}^{B} ← \{ 0 , 1 \}$ |
| 5. | for k = {0, 1, . . . , M − 1} do |
| 6. | ${P}_{0} sets {t}_{j , k} = {[ e {q}_{0 , j} ]}_{0}^{B} ⊕ 1 \{ {x}_{j} = k ) \}$ |
| 7. | end for |
| 8. | P₀ and P₁ invoke an instance of 1 out of M OT where P₀ is |

$\begin{matrix}the sender with inputs {\{ {t}_{j , k} \}}_{k} and {P}_{1} is the \\ receiver with input {y}_{j} . {P}_{1} sets its output {as [ {eq}_{0 , j} ]}_{1}^{B}\end{matrix}$

| | |
|---|---|
| 9. | end for |
| 10. | For i = {1, . . . , log(q)} do |
| 11. | For j = {0, . . . , (q/2ⁱ) − 1} do |
| 12. | $\begin{matrix}For b ∈ \{ 0 , 1 \} , Party binvokes AND with inputs \\ {[ {eq}_{i - 1 , 2 j} ]}_{b}^{B} and {[ e {q}_{i - 1 , 2 j + 1} ]}_{b}^{B} to learn {output [ {eq}_{i , j} ]}_{b}^{B} .\end{matrix}$ |
| 13. | End For |
| 14. | End For |
| 15. | $For b ∈ \{ 0 , 1 \} , Party {boutputs [ b ]}^{B} = {[ {eq}_{log ( q ) , 0} ]}_{b}^{B} .$ |

```
  Algorithm 11: SecureEquality(x, y)
  Input: P₀ holds x₀; P₁ holds x₁.
  Output: P₀, P₁ learn 1{x₀ = x₁}.
  Offline: P₀ and P₁ generate OLE Tuples:
```

| | |
|---|---|
| 1. | Suppose two-party secure computation over a ring 2^{l}, define |

OLE Tuples over a prime field F_{q}, where q is the smallest prime that
greater than 2^{l}

| | |
|---|---|
| 2. | ${P}_{0} and {P}_{1} generate non - zero numbers {r}_{0}^{0} , {s}_{0}^{0} and {r}_{1}^{0} , {s}_{1}^{0} over$ |

${F}_{q} , respectively . They satisfy {r}_{0}^{0} * {r}_{1}^{0} = {s}_{0}^{0} + {s}_{1}^{0} mod q$

| | |
|---|---|
| 3. | ${P}_{0} and {P}_{1} generate non - zero numbers {r}_{0}^{1} , {s}_{0}^{1} and {r}_{1}^{1} , {s}_{1}^{1} over$ |

${F}_{q} , respectively . They satisfy {r}_{0}^{1} * {r}_{1}^{1} = {s}_{0}^{1} + {s}_{1}^{1} mod q$
Online:

| | |
|---|---|
| 1. | ${P}_{0} computes {u}_{0} = ( {s}_{0}^{0} - {x}_{0} ) mod q and sends {u}_{0} to {P}_{1} .$ |
| 2. | ${P}_{1} computes {u}_{1} = ( {s}_{1}^{1} - {x}_{1} ) mod q and sends {u}_{1} to {P}_{0} .$ |
| 3. | ${P}_{0} computes {v}_{0} = \frac{( {u}_{1} + {x}_{0} + {s}_{0}^{1} )}{{r}_{0}^{1}} mod q and {v}_{0} to {P}_{1} .$ |
| 4. | ${P}_{1} computes {v}_{1} = \frac{( {u}_{0} + {x}_{1} + {s}_{1}^{0} )}{{r}_{1}^{0}} mod q and {v}_{1} to {P}_{0} .$ |
| 5. | $\begin{matrix}{P}_{0} and {P}_{1} set their output as 1 \{ {v}_{1} = {r}_{0}^{0} \} and \\ 1 \{ {v}_{0} = {r}_{1}^{1} \} , respectively .\end{matrix}$ |

### Sampling Discrete Gaussian Distribution

Different techniques can be used to generate samples according to discrete Gaussian distribution. Algorithm 12 described below is an example technique for sampling discrete Gaussian, for example, based on the Laplace distribution (e.g., using the example Algorithm 6 of

$${SamplingLaplace}_{ℤ , N}^{A} ( t )$$

described above) and acceptance bits generated using the Bernoulli sampling (e.g., using one of the example Algorithms 7-8 of

$${SamplingBernoulli}_{exp}^{B} ( {[ {u}_{i} ]}^{B} , r )$$

described above).

```
  Algorithm 12: [symbol]  (σ, m)
  Input: parameters σ of Discrete Gaussian distribution, and sample
number m
  Output: m samples [s₁]^{A}, . . . , [sₘ]^{A}, and the acceptance bits
[b₁]^{B}, . . . , [bₘ]^{B}. where the accepted samples follow [symbol]  .
  $Precompute : \{ \begin{matrix}t = {σ}^{2} / ⌊ σ ⌉ , r = 2 {σ}^{2} & σ \geq 1 \\ t = {σ}^{2} ⌊ 1 / σ ⌉ , r = 2 {σ}^{2} ⌊ 1 / σ ⌉ & σ \geq 1\end{matrix}$
```

| 1. | For i ← 1 to m do | | |
|---|---|---|---|
| | a. | ${[ {s}_{i} ]}^{A} , {[ \vert {s}_{i} \vert ]}^{A} = {SamplingLaplace}_{ℤ , N}^{A} ( t )$ | |
| | b. | If σ [symbol] 1 | |
| | | i. | [uᵢ]^{A} = ([\|sᵢ\|]^{A} − └σ┐)² |
| | c. | Else | |
| | | i. | [uᵢ]^{A} = ([\|sᵢ\|]^{A} * ┌1/σ┐ − 1)² |

| | |
|---|---|
| d. | End If |
| e. | [u₁]^{B} = A2B([uᵢ]^{A}) |
| f. | ${[ {b}_{i} ]}^{B} = {SamplingBernoulli}_{exp}^{B} ( {[ {u}_{i} ]}^{B} , r )$ |

| | |
|---|---|
| 2. | End For |

Algorithm 13 described below is an example technique for generating n samples according to a discrete Gaussian distribution, for example, using the example Algorithm 12 of [symbol] (σ′m) described above.

Algorithm 13: [symbol] (σ′ n)

| Input: parameters σ of Discrete Gaussian distribution, and sample | |
|---|---|
| number n | |
| Output: n samples follow [symbol] (σ). | |
| 1. | ([s₁]^{A,} [b₁]^{B}),..., ([sₘ]^{A,} [bₘ]^{B}) = [symbol] (σ′ m) |
| 2. | Initialize set X |
| 3. | For i ← 1 to m do |

| | |
|---|---|
| a. | bᵢ = Reveal([bᵢ]^{B}), which reveals the private input bᵢ, whose |

secret share is [bᵢ]^{B}.

| | |
|---|---|
| b. | If bᵢ = 1, add [sᵢ]^{A} to Set X |

| | |
|---|---|
| 4. | End For |
| 5. | Return X |

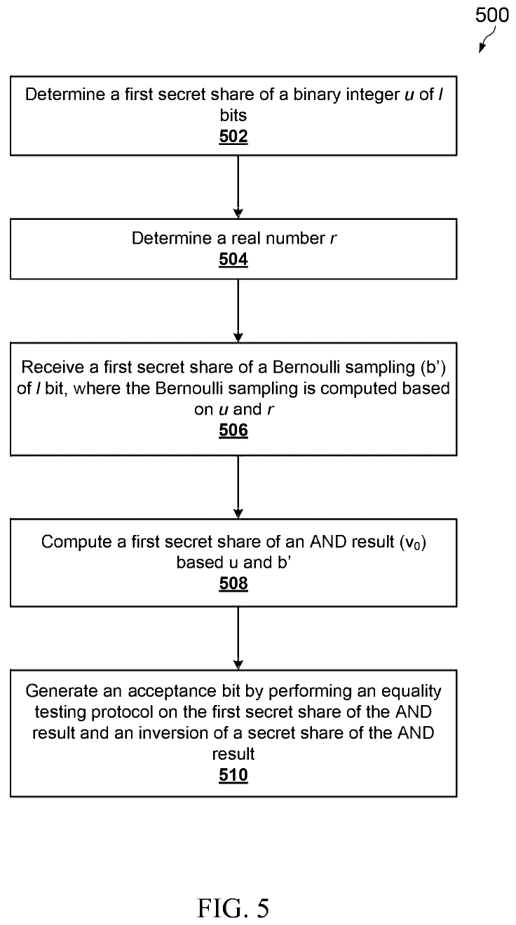

FIG. 5 is a flow diagram of an example process 500 for performing a Bernoulli sampling. The example process 500 can be used for sampling an acceptance bit (or a rejection bit) (308), for example, for generating a Gaussian sample based on a Laplace sample. The example process 500 can be an implementation of the Bernoulli sampling of an acceptation bit according to the ratio of the Gaussian distribution to the Laplacian distribution as described above. The operations shown in process 500 may not be exhaustive and that other operations can be performed as well before, after, or in between any of the illustrated operations. Further, some of the operations may be performed simultaneously, or in a different order than shown in FIG. 5.

For convenience, the process 500 will be described as being performed by a system of one or more computers (e.g., a server implemented by a computer system 600 of FIG. 6), located in one or more locations, and programmed appropriately in accordance with this specification. For example, a multi-party computation system, e.g., the multi-party computation system 100 of FIG. 1, appropriately programmed, can perform the process 500.

In particular, the process 500 is described from the perspective of a first party, e.g., a first party P0 implemented by a first server, of the multi-party computation system. Operations of another party, e.g., a second party P1 implemented by a second server, of the multi-party computation system can be determined accordingly.

In some implementations, the process 500 can be based on Algorithms 7 and 8 with a goal to sample a bit according to Bernoulli distribution Bₑᵣ(e^{(-u/r)}). The variable u is an integer value and r is a real number. Since e is continuous and r is continuous, some approximations need to be made to work with MPC. The approximation is desirable to be as accurate as is practicable. Since u is an integer, it means it can be represented as a binary form, for example, as

$${\sum }_{i = 0}^{l} {2}^{l} ( {u}_{i} ) .$$

Where l is the bit-length of the binary number, for example l=64 for a 64-bit representation of a particular integer number.

The first party determines a first secret share

$$( e . g . , {[ u ]}_{0}^{B} )$$

of the variable u (502), for example, based on one or more secrete sharing techniques. The second party receives a second secret share

$$( e . g . , {[ u ]}_{1}^{B} )$$

of the variable u.

The first party determines the real number r (504). Similarly, the second party determines the real number r.

Additionally, a property of Bernoulli sampling is that Bₑᵣ(P₁P₂)=Bₑᵣ(P₁)Bₑᵣ(P₂). This is equivalent to that two random Bernoulli samples, one from P₁ and one from P₂ the product of the samples should be the same as the Bernoulli of the product of the two random variables P₁ and P₂. As an illustrative example, sampling

$${B}_{e r} ( \frac{1}{4} )$$

is equivalent to flipping two coins and only outputting a result of 1 when two heads appear, otherwise the output is zero. This is equivalent to

$${B}_{e r} ( \frac{1}{2} ) {B}_{e r} ( \frac{1}{2} ) .$$

Additionally,

$${B}_{e r} ( {e}^{{(}^{- u} {/}_{r} )} ) = {B}_{e r} ( {e}^{{(}^{- 1} / r ) {\sum }_{i = 0}^{l} {2}^{l} ( {u}_{i} )} ) ,$$

which can be rewritten as:

$$\prod {B}_{e r} ( {e}^{\frac{- 1}{r} {2}^{i} {u}^{i}} ) .$$

If the input is the value of u, which corresponds to a secret shared integer, then the portion

$${e}^{\frac{- 1}{r} {2}^{i}}$$

is independent of the input and can be precomputed in advance. Also, since u is represented as a binary value, ui can only have two values, 0 or 1. If ui=0 then you have e0, which is equal to one. If ui=1, then the system computes Bernoulli sampling with probability

$${B}_{e r} ( {e}^{( - {2}^{i} / r )} ) .$$

### Since

$${e}^{( - {2}^{i} / r )}$$

can be precomputed as pi, which is independent of the actual input u, it provides the approximation that can be sampled.

The first party receives a first secret share of a Bernoulli sampling (b′) of l bits (506). The second party receives a second secret share of the Bernoulli sampling (b′) of l bits. Each bit (bᵢ′) in b′ is generated by performing a Bernoulli sampling protocol (e.g., as shown in Algorithms 1-3) with pi as an input to the Bernoulli sampling protocol.

The first party then computes a first secret share of an AND result (e.g.,

$${[ v ]}_{0}^{B}$$

in Algorithm 8) based on the first secret share of b′ and the first secret share of the variable u (508), such that:

$${[ v ]}_{{0}^{=}}^{B} ¬ ( {[ u ]}_{0}^{B} \& ( ¬ {[ {b}^{′} ]}_{0}^{B} ) )$$

The second party computes a second secret share of the AND result (e.g.,

$${[ v ]}_{1}^{B}$$

in Algorithm 8) based on the second secret share of b′ and the second secret share of the variable u, such that:

$${[ v ]}_{1}^{{B}_{=}} ¬ ( {[ u ]}_{1}^{B} \& ( ¬ {[ {b}^{′} ]}_{1}^{B} ) )$$

The AND result represents an AND result of all bits (bᵢ′) in b′ with a corresponding uᵢ where uᵢ=1. Specifically, all values of the individual Bernoulli sampling results have to be equal to one to get a final result of one. If there is a zero, then the final result is an AND result with at least one zero term, resulting in a final result of zero. Thus, if uⁱ=0, then e⁰ is equal to one, and so Ber(1)=1. If uⁱ=1, then the system computes

$${B}_{e r} ( {e}^{( - {2}^{i} / r )} ) ,$$

which is equal to one to get a final result of one. In some implementations, the AND result (e.g.,

$${[ v ]}_{0}^{B}$$

in Algorithm 8) can be computed based on the above equation or can be computed in another equivalent manner.

An acceptance bit (e.g., in the form of secret share [b]^{B} in Algorithm 8) can be generated by performing an equality testing protocol (e.g., the equality testing protocols as shown in Algorithms 9-11) on the first secret share of the AND result, and an inversion of the second secret share of the AND results (510), such that:

$${[ b ]}^{B} = SecureEquality ( {[ v ]}_{0}^{B} , ¬ {[ v ]}_{1}^{B} )$$

The system uses the acceptance bit to accept or reject a discrete Laplacian sample as a representation of a discrete Gaussian sample. For example, if the final output is 1, then the acceptance bit is 1 and the sample of the Laplacian distribution is accepted. If the final output is zero, the acceptance bit is 0 and the sample of the Laplacian distribution is rejected.

Algorithm 7 and Algorithm 8 illustrate two example techniques for performing the Bernoulli sampling of the acceptance bit described above. Both perform the precomputation of pᵢ described above. In Algorithm 7, AND operations are performed to determine whether the AND result (e.g. [v]^{B}) comprises all “one” bits. For example, AND operations are performed among all bits of [v]^{B}, such that the final result is 1 (which indicates acceptance) when and only when each bit in [v]^{B} is one. If there is one or more “zero” bits in [v]^{B}, the final result will be 0 (which indicates rejection). Algorithm 7 requires multiple rounds of AND operations. In Algorithm 8, the evaluation can be performed in a single round of AND operation using an equality testing protocol.

The techniques for generating the acceptance bit can have lower complexity as compared to previous techniques. For example, some techniques require l rounds, which has higher round complexity between the two parties, which can further cause latency delays. Additionally, communication complexity, the amount of data sent between the parties during computation, can also be reduced. In Algorithm 8, the final step relates to secure equality testing. Secure equality testing is a primitive used in MPC that allows each party to determine if two private values are equal without disclosing the values themselves. There are different secure equality protocols that can be used. Algorithms 9-11 are example protocols used for equality testing, which can be used in the described Bernoulli sampling of the acceptance bit. In some implementations, as shown by Algorithms 9-10, the equality testing protocol is performed based on Oblivious Transfer, such that parties of the secure MPC only possess secret shares of the acceptance bit, and do not know the actual value of the acceptance bit. In some implementations, as shown by Algorithm 11, the equality testing can be performed based on Oblivious Linear Evaluation (OLE) tuples, such that the actual value of the acceptance bit is revealed to the parties.

FIG. 6 is an example computer system 600. The system 600 can be used for the operations described in association with the implementations described herein, for example, as a server of a party participating in a multiparty computation (MPC) instance. For example, the system 600 may be included in computing devices of the one or more online components and/or the one or more offline components. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 520 or on the storage device 630 to display graphical information for a user interface on the input/output device 640.

The memory 620 stores information within the system 600. In some implementations, the memory 620 is a computer-readable medium. The memory 620 can be a volatile memory unit or a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

In this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers.

The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
generating, by a first server of a first party of two or more parties participating in a secure multiparty computation (MPC) instance, a first l-bit random number, where l is a positive integer;
comparing a XOR result of the first l-bit random number and a second l-bit random number with an integer determined based on a target probability of a Bernoulli distribution, wherein the comparing comprises performing a comparison protocol based on oblivious transfer; and
determining a Bernoulli sampling of a random number based on a result of the comparing.

2. The method of claim 1, wherein the second l-bit random number is generated by a second server of a second party of the two or more parties participating in the secure MPC instance.

3. The method of claim 1, wherein the integer is a product of the target probability and 2^{l}.

4. The method of claim 1, wherein comparing the XOR result with the integer comprises:
partitioning the first l-bit random number into N sections and partitioning the integer into N sections, where N is a positive integer;
determining whether the XOR result is smaller than the integer based on first indicators and second indicators corresponding to the N sections, wherein:
the first indicators comprise a first indicator that indicates a comparison result between xⱼ⊕yⱼ and uⱼ computed based on oblivious transfer, wherein xⱼ is a j^{th} section of the first l-bit random number, yⱼ is a j^{th} section of N sections of the second l-bit random number, uⱼ is a j^{th} section of the integer, and j=0, 1, . . . , N-1, and symbol ⊕ represents XOR; and
the second indicators comprise a second indicator that indicates whether xⱼ⊕yⱼ is a most significant section among sections of the XOR result where xⱼ⊕yⱼ≠uⱼ.

5. The method of claim 4, comprising:
for the j^{th} section (xⱼ) of the first l-bit random number:
receiving, by the first server of the first party, a first secret share of the first indicator;
sending, to a second server of a second party of the one or more parties, a second secret share of the first indicator;
receiving, by the first server of the first party, a first secret share of the second indicator; and
sending, to the second server of the second party, a second secret share of the second indicator.

6. The method of claim 5, further comprising:
receiving, by the first server of the first party, a first secret share of a third indicator that indicates whether xⱼ⊕yⱼ=uⱼ, wherein the first secret share of the second indicator is computed based on the first secret share of the third indicator.

7. The method of claim 4, wherein each of the N sections of the first l-bit random number comprises M bit, where M is a positive integer, wherein the first indicator corresponding xⱼ is generated by:
generating, by the first server of the first party, a first random bit as a first secret share of the first indicator;
generating, by the first server of the first party based on the first random bit, a group of 2^{M} bits; and
sending, to the second server of the second party, a bit selected from the group of 2^{M} bits as a second secret share of the first indicator, wherein the bit is selected based on yⱼ.

8. The method of claim 1, further comprising:
using the Bernoulli sampling of the l-bit random number to generate a random noise value; and
adding the random noise value to an MPC computation result according to a differential privacy mechanism before sharing the computation result with one or more other parties.

9. The method of claim 8, wherein using the Bernoulli sampling of the random number to generate a random noise value comprises:
using the Bernoulli sampling to generate a geometric distribution;
using the geometric distribution to generate a discrete Laplacian distribution;
using the discrete Laplacian distribution to sample a discrete Gaussian distribution; and
using the sampling of the discrete Gaussian distribution to generate the random noise value.

10. One or more computer-readable storage media storing one or more instructions that, when executable by one or more computers, cause the one or more computers to perform operations comprising:
generating, by a first server of a first party of two or more parties participating in a secure multiparty computation (MPC) instance, a first l-bit random number, where l is a positive integer;
comparing a XOR result of the first l-bit random number and a second l-bit random number with an integer determined based on a target probability of a Bernoulli distribution, wherein the comparing comprises performing a comparison protocol based on oblivious transfer; and
determining a Bernoulli sampling of a random number based on a result of the comparing.

11. The one or more computer-readable storage media of claim 10, wherein the second l-bit random number is generated by a second server of a second party of the two or more parties participating in the secure MPC instance.

12. The one or more computer-readable storage media of claim 10, wherein the integer is a product of the target probability and 2^{l}.

13. The one or more computer-readable storage media of claim 10, wherein comparing the XOR result with the integer comprises:
partitioning the first l-bit random number into N sections and partitioning the integer into N sections, where N is a positive integer;
determining whether the XOR result is smaller than the integer based on first indicators and second indicators corresponding to the N sections, wherein:
the first indicators comprise a first indicator that indicates a comparison result between xⱼ⊕yⱼ and uⱼ computed based on oblivious transfer, wherein xⱼ is a j^{th} section of the first l-bit random number, yⱼ is a j^{th} section of N sections of the second l-bit random number, uⱼ is a j^{th} section of the integer, and j=0, 1, . . . , N-1, and symbol ⊕ represents XOR; and
the second indicators comprise a second indicator that indicates whether xⱼ⊕yⱼ is a most significant section among sections of the XOR result where xⱼ⊕yⱼ≠uⱼ.

14. The one or more computer-readable storage media of claim 13, wherein the operations further comprise:
for the j^{th} section (xⱼ) of the first l-bit random number:
receiving, by the first server of the first party, a first secret share of the first indicator;
sending, to a second server of a second party of the one or more parties, a second secret share of the first indicator;
receiving, by the first server of the first party, a first secret share of the second indicator; and
sending, to the second server of the second party, a second secret share of the second indicator.

15. The one or more computer-readable storage media of claim 14, wherein the operations further comprises:
receiving, by the first server of the first party, a first secret share of a third indicator that indicates whether xⱼ⊕yⱼ=uⱼ, wherein the first secret share of the second indicator is computed based on the first secret share of the third indicator.

16. The one or more computer-readable storage media of claim 13, wherein the N sections of the first l-bit random number comprises M bit, where M is a positive integer, wherein the first indicator corresponding xⱼ is generated by:
generating, by the first server of the first party, a first random bit as a first secret share of the first indicator;
generating, by the first server of the first party based on the first random bit, a group of 2^{M} bits; and
sending, to the second server of the second party, a bit selected from the group of 2^{M} bits as a second secret share of the first indicator, wherein the bit is selected based on yⱼ.

17. The one or more computer-readable storage media of claim 10, wherein the operations further comprise:
using the Bernoulli sampling of the random number to generate a random noise value; and
adding the random noise value to an MPC computation result according to a differential privacy mechanism before sharing the computation result with one or more other parties.

18. The one or more computer-readable storage media of claim 17, wherein using the Bernoulli sampling of the l-bit random number to generate a random noise value comprises:
using the Bernoulli sampling to generate a geometric distribution;
using the geometric distribution to generate a discrete Laplacian distribution;
using the discrete Laplacian distribution to sample a discrete Gaussian distribution; and
using the sampling of the discrete Gaussian distribution to generate the random noise value.

19. A computer-implemented system, comprising:
one or more computers; and
one or more computer memory devices interoperably coupled with the one or more computers and having computer-readable storage media storing one or more instructions that, when executed by the one or more computers, perform one or more operations comprising:
generating, by a first server of a first party of two or more parties participating in a secure multiparty computation (MPC) instance, a first l-bit random number, where l is a positive integer;
comparing a XOR result of the first l-bit random number and a second l-bit random number with an integer determined based on a target probability of a Bernoulli distribution, wherein the comparing comprises performing a comparison protocol based on oblivious transfer; and
determining a Bernoulli sampling of a random number based on a result of the comparing.

20. The computer-implemented system of claim 19, wherein comparing the XOR result with the integer comprises:
partitioning the first l-bit random number into N sections and partitioning the integer into N sections, where N is a positive integer;
determining whether the XOR result is smaller than the integer based on first indicators and second indicators corresponding to the N sections, wherein:
the first indicators comprise a first indicator that indicates a comparison result between xⱼ⊕yⱼ and uⱼ computed based on oblivious transfer, wherein xⱼ is a j^{th} section of the first l-bit random number, yⱼ is a j^{th} section of N sections of the second l-bit random number, uⱼ is a j^{th} section of the integer, and j=0, 1, . . . , N-1; and
the second indicators comprise a second indicator that indicates whether xⱼ⊕yⱼ is a most significant section among sections of the XOR result where xⱼ⊕yⱼ≠uⱼ.
